(19) United States
(12) Patent Application Publication
(10) Pub. No.: US 2026/0281881 A1
(43) Pub. Date: Sep. 17, 2026

(54) INFORMATION PROCESSING DEVICE AND METHOD

(71) Applicant: TOYOTA JIDOSHA KABUSHIKI KAISHA, Toyota-shi (JP)

(72) Inventors: Kazuya OKADA, Tokyo (JP); Hiroshi ABE, Kasukabe-shi (JP); Toru FURUSAWA, Yokohama-shi (JP); Tomoko MASUDA OKUZAWA, Tokyo (JP)

(73) Assignee: TOYOTA JIDOSHA KABUSHIKI KAISHA, Toyota-shi (JP)

(21) Appl. No.: 19/535,254

(22) Filed: Feb. 10, 2026

(30) Foreign Application Priority Data
Mar. 17, 2025 (JP) 2025-042673

(51) Int. Cl. H04W 48/16; H04W 48/18

(52) U.S. Cl. CPC H04W 48/16; H04W 48/18

(57) ABSTRACT

An information processing device connectable to at least two access networks managed by different administrators is configured to: acquire first information about utilization of renewable energy for each of the at least two access networks; and select an access network to be used from the at least two access networks based on the first information for each of the at least two access networks. The first information includes a renewable energy utilization rate in a wireless communication system that manages the access network. A control unit is configured to select, as the access network to be used, an access network with a higher value of the renewable energy utilization rate.

### CROSS-REFERENCE TO RELATED APPLICATION

This application claims priority to Japanese Patent Application No. 2025-042673 filed on Mar. 17, 2025. The disclosure of the above-identified application, including the specification, drawings, and claims, is incorporated by reference herein in its entirety.

### BACKGROUND

### 1. Technical Field

The present disclosure relates to wireless communications.

### 2. Description of Related Art

There has been disclosed a SIM that monitors the status of connection to a first carrier network, switches the connected carrier network from the first carrier network to a second carrier network when a problem occurs with the connection to the first carrier network, and attempts to switch back to the first carrier network when a predetermined condition is satisfied (e.g., Japanese Patent No. 7478277 (JP 7478277 B)).

### SUMMARY

One aspect of the disclosure is to provide an information processing device and a method that can reduce the amount of carbon dioxide emissions caused by wireless communication.

One aspect of the present disclosure is an information processing device connectable to at least two access networks managed by different administrators. The information processing device includes a control unit configured to:

acquire first information about utilization of renewable energy for each of the at least two access networks; and

select an access network to be used from the at least two access networks based on the first information for each of the at least two access networks.

Another aspect of the present disclosure is a method to be executed by an information processing device connectable to at least two access networks managed by different administrators. The method includes:

acquiring first information about utilization of renewable energy for each of the at least two access networks; and

selecting an access network to be used from the at least two access networks based on the first information for each of the at least two access networks.

According to the one aspect of the present disclosure, it is possible to reduce the amount of carbon dioxide emissions caused by wireless communication.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a process executed by UE according to a first embodiment;

FIG. 2 is a diagram showing an example of a hardware configuration of the UE;

FIG. 3 shows an example of a functional configuration of the UE; and

FIG. 4 shows an example of a flowchart of a process for selecting an access network by the UE.

### DETAILED DESCRIPTION OF EMBODIMENTS

For example, renewable energy is used in mobile communication systems to reduce the amount of carbon dioxide emissions caused by mobile communication. However, there is no practice on a subscriber side to select an access network in consideration of renewable energy.

In one aspect of the present disclosure, an access network is selected in consideration of renewable energy. More specifically, one aspect of the present disclosure is an information processing device connectable to at least two access networks managed by different administrators. The information processing device includes a control unit configured to: acquire first information about utilization of renewable energy for each of the at least two access networks; and select an access network to be used from the at least two access networks based on the first information for each of the at least two access networks. The first information may include a renewable energy utilization rate in a wireless communication system that manages the access network, or may include a renewable energy utilization rate in a device that accommodates an access network in which the information processing device is currently located or expected to be located. The control unit may be configured to select, as the access network to be used, an access network with a higher value of the renewable energy utilization rate.

Examples of the information processing device include an in-vehicle device mounted on a vehicle, a smartphone, a tablet terminal, a wearable terminal, and a wireless communication terminal connectable to a plurality of access networks managed by different administrators. Examples of the in-vehicle device include a data communication module (DCM), a car navigation device, a drive recorder, and an electronic control unit (ECU). The control unit may be a processor such as a central processing unit (CPU), a data processing unit (DPU), a graphics processing unit (GPU), or a digital signal processor (DSP), or an integrated circuit such as an application specific integrated circuit (ASIC), a field programmable gate array (FPGA), or a complex programmable logic device (CPLD).

Examples of the access networks include 5G, 4G (LTE-Advanced), LTE, 3G, pre-3G, and post-5G mobile communication carrier networks, Wi-Fi networks, WiMAX networks, and Bluetooth (registered trademark) networks. The at least two access networks managed by different administrators may include, for example, a combination of carrier networks of different carriers, a carrier network and a Wi-Fi network, and Wi-Fi networks managed by different administrators. Examples of the device that accommodates the access network include base stations such as 5G gNBs and 4G eNBs, Wi-Fi access points, WiMAX base stations, and Bluetooth (registered trademark) access points and gateways.

When the at least two access networks are different carrier networks, the information processing device further includes a first embedded universal integrated circuit card (eUICC) that holds information to be used for connection to a first carrier network, and a second eUICC that holds information to be used for connection to a second carrier network. The control unit may be configured to: acquire the first information for each of the first carrier network and the second carrier network; and select the access network to be used from the first carrier network and the second carrier network based on the first information for each of the first carrier network and the second carrier network.

According to the one aspect of the present disclosure, the access network to be used is selected from the at least two access networks based on the first information about the utilization of renewable energy. The amount of carbon dioxide emissions caused by wireless communication can be reduced, for example, by selecting the access network with a higher renewable energy utilization rate.

Other aspects of the present disclosure can be specified as a method in which a computer executes the process to be executed by the above information processing device, a program for causing a computer to execute the process to be executed by the above information processing device, and a computer-readable recording medium recording the program.

Hereinafter, embodiments of the present disclosure will be described with reference to the drawings. The configurations of the following embodiments are illustrative, and the present disclosure is not limited to the configurations of the embodiments.

### First Embodiment

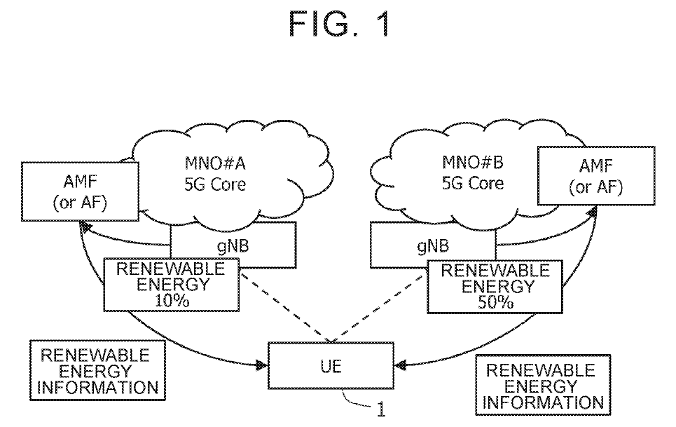

FIG. 1 is a diagram showing an example of a process executed by user equipment (UE) 1 according to a first embodiment. The first embodiment has a precondition that the UE 1 is a terminal that supports mobile communication systems up to 5G. In FIG. 1, the UE 1 can use carrier networks of two mobile network operators (MNOs), namely MNO #A and MNO #B.

In the first embodiment, the UE 1 acquires renewable energy information of a gNB around which the UE 1 is currently located or expected to be located from the access and mobility management function (AMF) in the 5G core of each of MNO #A and MNO #B. The renewable energy information includes, for example, the renewable energy utilization rate of the relevant gNB. Based on the renewable energy information of the gNB of MNO #A and the renewable energy information of the gNB of MNO #B, the UE 1 selects a carrier network with a higher renewable energy utilization rate as an access network to be used. In the example shown in FIG. 1, the renewable energy utilization rate of the gNB of MNO #A is 10%, and the renewable energy utilization rate of the gNB of MNO #B is 50%. Therefore, the UE 1 selects the carrier network of MNO #B for communication.

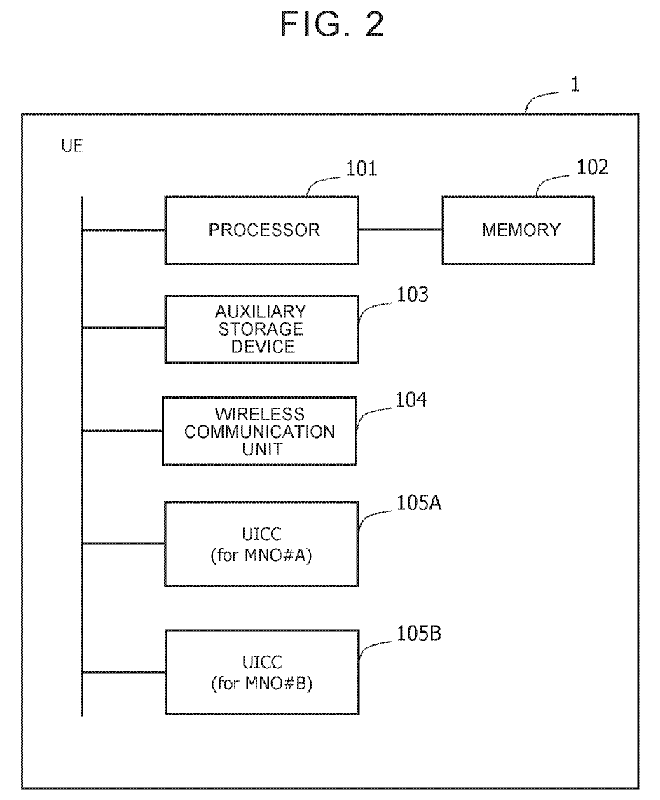

FIG. 2 is a diagram showing an example of a hardware configuration of the UE 1. The UE 1 is, for example, a vehicle, an in-vehicle device, a smartphone, a tablet terminal, a wearable terminal, or a personal computer (PC). The in-vehicle device is, for example, a DCM, a car navigation device, a drive recorder, or an ECU. The UE 1 includes, as its hardware configuration, a processor 101, a memory 102, an auxiliary storage device 103, a wireless communication unit 104, a UICC 105A, and a UICC 105B. The auxiliary storage device 103 is, for example, a hard disk drive (HDD) or a solid state drive (SSD). Programs held in the auxiliary storage device 103 include, for example, an operating system (OS), a communication control program, and a plurality of other programs. The communication control program is a program for selecting an access network based on the renewable energy utilization rate. The memory 102 includes, for example, a semiconductor memory such as a read-only memory (ROM) or a random access memory (RAM). The memory 102 and the auxiliary storage device 103 are each an example of a computer-readable recording medium.

The processor 101 executes various processes by loading the OS and various other programs held in the auxiliary storage device 103 into the memory 102 and executing them. The processor 101 may be, for example, a CPU, a DSP, a GPU, or a DPU, or may be an integrated circuit such as an ASIC, an FPGA, or a CPLD. The number of processors 101 is not limited to one, and a plurality of processors may be provided. The processor 101 is an example of a "control unit." In the first embodiment, the wireless communication unit 104 communicates with an external device based on the 5G mobile communication system. When the carrier network is a system that supports mobile communication systems of 5G onwards, the wireless communication unit 104 also supports the mobile communication systems supported by the carrier network.

The UICC 105A is a UICC for MNO #A in the example shown in FIG. 1. The UICC 105B is a UICC for MNO #B in the example shown in FIG. 1. The UICC 105A and the UICC 105B hold profile information to be used when connecting to MNO #A and MNO #B, respectively. The profile information includes, for example, a plurality of pieces of identification information and key information to be used for authentication and encryption. The UICC 105A and the UICC 105B may be either a chip-type or card-type eUICC, or a card-type removable UICC. When at least one of the UICC 105A or the UICC 105B is a card-type UICC, the UE 1 includes a SIM slot, a SIM card reader, etc. The hardware configuration of the UE 1 is not limited to the configuration shown in FIG. 2.

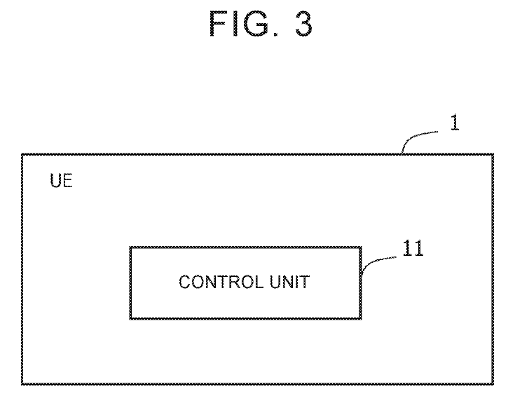

FIG. 3 shows an example of a functional configuration of the UE 1. The UE 1 includes a control unit 11 as its functional configuration. The process to be executed by the control unit 11 is achieved by the processor 101 of the UE 1 executing the communication control program held in the auxiliary storage device 103.

The control unit 11 selects an access network to be used when a trigger condition for selection of an access network is satisfied. Selecting the access network to be used from the carrier network of MNO #A or the carrier network of MNO #B means selecting which of the UICC 105A and the UICC 105B is to be used. The trigger condition for selection of an access network is, for example, the occurrence of any of the following: start of data communication, start of connection or reconnection to the carrier network of MNO #A or the carrier network of MNO #B, and handover. However, the trigger condition for selection of an access network is not limited to these.

When the trigger condition is the start of data communication, a UICC to be used for the data communication is selected. The start of data communication is detected by, for example, a user operation indicating the start of data communication and input to the UE 1, or a data transmission request from an application. When the trigger condition is the start of connection or reconnection to the carrier network of MNO #A or the carrier network of MNO #B, a UICC on standby for data reception is selected. The UICC on standby for data reception is a UICC to be used for data reception such as reception of calls using a calling application or reception of emails in a standby state in which neither a call nor data communication is currently performed.

Examples of the handover as the trigger condition include handover from Wi-Fi to a carrier network during data communication, and handover from Wi-Fi to a carrier network, handover between gNBs within the same carrier network, and handover from 4G to 5G or from 5G to 4G within the same carrier network while neither data communication nor a call is currently performed. When handover from Wi-Fi to a carrier network occurs during data communication, the UICC to be used for the data communication is selected. When handover from Wi-Fi to a carrier network, handover between gNBs within the same carrier network, or handover from 4G to 5G or from 5G to 4G within the same carrier network occurs while neither data communication nor a call is currently performed, the UICC on standby for data reception is selected. A UICC to be used to make and receive calls and to send and receive SMS is necessarily determined based on a telephone number etc. Therefore, in the first embodiment, these are not included in the trigger condition. The trigger condition for selection of an access network is not limited to the above conditions. The UICC to be used for data communication and the UICC on standby for data reception are collectively referred to as "UICCs to be used for communication."

When the trigger condition is satisfied, the control unit 11 transmits a request to MNO #A and MNO #B and acquires pieces of renewable energy information from MNO #A and MNO #B, respectively. Identification information of a base station around which the UE 1 is currently located and/or a base station around which the UE 1 is expected to be located (at the time of handover), i.e., a base station from which the UE 1 is detecting a received radio wave, is transmitted together with the request, and renewable energy information about the base station is received from each of MNO #A and MNO #B. The base stations may include, for example, gNBs and eNBs. The identification information of the base station transmitted together with the request may be, for example, a cell ID.

The control unit 11 selects a carrier network with a higher renewable energy utilization rate as the access network to be used based on the renewable energy information about the base station of each of MNO #A and MNO #B around which the UE 1 is currently located or expected to be located. For example, when the trigger condition is the start of data communication, the start of connection or reconnection to the carrier network of MNO #A or the carrier network of MNO #B, or handover from Wi-Fi to a carrier network, the renewable energy utilization rates are compared between the base stations of MNO #A and MNO #B around which the UE 1 is currently located. For example, when the trigger condition is handover between gNBs within the same carrier network or handover from 4G to 5G or from 5G to 4G within the same carrier network, the renewable energy utilization rates are compared between the base station of MNO #A or MNO #B around which the UE 1 is expected to be located such that the handover will occur and the base station of the other around which the UE 1 is currently located.

In the 5G core, the renewable energy utilization rate of each base station is managed by a network function (NF) such as an access and mobility management function (AMF), a network data analytics function (NWDAF), and/or an NF that manages information about renewable energy. The UE 1 may transmit a request for renewable energy information to the AMF, for example, in a data plane. In response to the request from the UE 1, the AMF may generate renewable energy information about the relevant base station and transmit it to the UE 1. When the AMF does not hold the renewable energy utilization rate of each base station, the AMF may query each base station or other NFs such as the NWDAF to acquire the renewable energy utilization rate of the relevant base station and generate renewable energy information about the relevant base station.

Alternatively, the UE 1 may transmit a request for renewable energy information to an application function (AF). In this case, the AF may transmit a request for renewable energy information of the relevant base station to a network exposure function (NEF) to acquire the renewable energy information of the relevant base station through the NEF, for example, from the AMF or NWDAF, and transmit it to the UE 1. The functional configuration of the UE 1 is not limited to the example shown in FIG. 3.

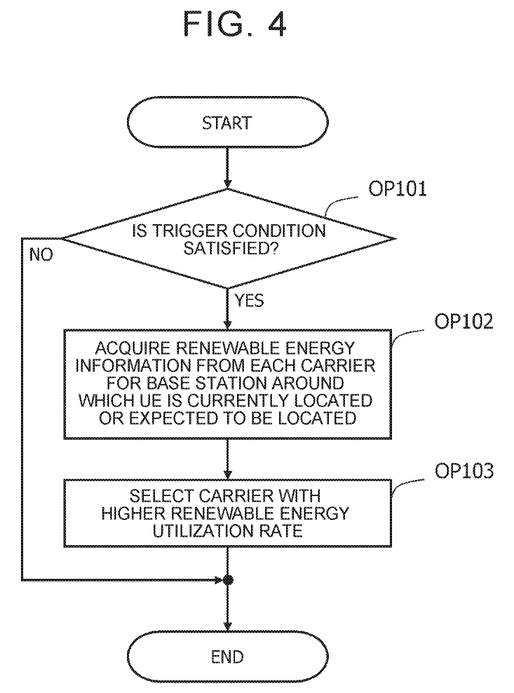

FIG. 4 shows an example of a flowchart of a process for selecting an access network by the UE 1. The process shown in FIG. 4 is repeatedly executed while the UE 1 is in operation. Although the process shown in FIG. 4 is executed by the processor 101 of the UE 1, description will be given on the precondition that the process is executed by functional components for convenience.

In OP101, the UE 1 determines whether the trigger condition for selection of an access network is satisfied. When the trigger condition is satisfied (OP101: YES), the process proceeds to OP102. When the trigger condition is not satisfied (OP101: NO), the process shown in FIG. 4 ends.

In OP102, the UE 1 transmits requests to MNO #A and MNO #B to acquire, from MNO #A and MNO #B, pieces of renewable energy information of base stations around which the UE 1 is currently located or expected to be located. In OP103, the UE 1 selects, as the access network to be used, a carrier network of the MNO with a higher renewable energy utilization rate based on the renewable energy information of the base station of MNO #A around which the UE 1 is currently located or expected to be located and the renewable energy information of the base station of MNO #B around which the UE 1 is currently located or expected to be located. Then, the process shown in FIG. 4 ends.

### Actions and Effects of First Embodiment

In the first embodiment, the UE 1 acquires pieces of renewable energy information about base stations of MNO #A and MNO #B around which the UE 1 is currently located or expected to be located, and selects the access network to be used from the carrier network of MNO #A or the carrier network of MNO #B based on the pieces of renewable energy information. Thus, the UE 1 can select the access network in consideration of renewable energy. In the first embodiment, the carrier network of the MNO with a higher renewable energy utilization rate is selected as the access network to be used. This can reduce the amount of carbon dioxide emissions caused by mobile communication.

### Other Modifications

The embodiment described above is merely exemplary, and the present disclosure may be modified as appropriate without departing from the spirit and scope of the present disclosure.

In the first embodiment, the UE 1 acquires pieces of renewable energy information about base stations around which the UE 1 is currently located or expected to be located, and selects the access network to be used from the carrier network of MNO #A or the carrier network of MNO #B based on the pieces of renewable energy information. Alternatively, for example, the carrier network of the MNO with a higher renewable energy utilization rate across the entire MNO may be selected based on pieces of renewable energy information of the entire MNO #A and the entire MNO #B.

The renewable energy information may include information such as the type of renewable energy, the amount of electric power generated by the renewable energy, or the remaining amount of electric power in addition to the renewable energy utilization rate. Examples of the renewable energy include solar energy, wind energy, hydroelectric energy, biomass energy, geothermal energy, tidal energy, and wave energy. The UE 1 may select the access network to be used in consideration of the type of renewable energy, the power generation capacity, the remaining amount of electric power, etc. in addition to the renewable energy utilization rate. For example, the UE 1 may assign priority levels to the types of renewable energy, and when the utilization rates are about the same, select the carrier network of the MNO with a higher priority level of the type of renewable energy.

In addition to the acquisition of renewable energy information, the UE 1 may measure the quality of communication with the base station around which the UE 1 is currently located or expected to be located, and select the access network to be used based on the communication quality in addition to the renewable energy utilization rate. For example, the UE 1 may select a carrier network with its communication quality that satisfies a predetermined condition even when the renewable energy utilization rate is lower than a predetermined threshold, rather than a carrier network with its communication quality that does not satisfy the predetermined condition even when the renewable energy utilization rate is higher than the predetermined threshold.

In the first embodiment, when the trigger condition for selection of an access network is satisfied, the UE 1 transmits a request to each carrier network to acquire renewable energy information. Alternatively, the UE 1 may periodically acquire renewable energy information from each carrier network at predetermined intervals, and when the trigger condition is satisfied, select the access network to be used based on the latest renewable energy information. In this case, the renewable energy information may be acquired through a control plane. Alternatively, the renewable energy information may be transmitted to the UE 1 from each carrier network periodically at predetermined intervals.

The first embodiment illustrates the example in which the access network to be used is selected from the two different carrier networks, but the technology described in the first embodiment can also be applied to a case where the access network to be used is selected from three or more different carrier networks. In this case, the UE 1 includes three or more UICCs. The technology described in the first embodiment can also be applied, for example, to a case where the access network to be used is selected from two or more Wi-Fi networks managed by different administrators, and to a case where the access network to be used is selected from different types of access network, such as a carrier network and a Wi-Fi network.

The processes and means described in the present disclosure can be freely combined and implemented as long as no technical contradiction occurs.

The process described as being executed by a single device may be executed by a plurality of devices in cooperation. Alternatively, the process described as being executed by different devices may be executed by a single device. In a computer system, the hardware configuration (server configuration) that implements functions can be changed flexibly.

The present disclosure may be embodied such that a computer program that implements the functions described in the above embodiment is supplied to a computer and is read and executed by one or more processors of the computer. Such a computer program may be provided to the computer by a non-transitory computer-readable storage medium that is connectable to a system bus of the computer, or may be provided to the computer via a network. Examples of the non-transitory computer-readable storage medium include any type of disk or disc such as a magnetic disk (floppy (registered trademark) disk, hard disk drive (HDD), etc.) and an optical disc (CD-ROM, DVD, Blu-ray disc, etc.), a read only memory (ROM), a random access memory (RAM), an EPROM, an EEPROM, a magnetic card, a flash memory, an optical card, and any type of medium suitable for storing electronic instructions.

What is claimed is:

1. An information processing device connectable to at least two access networks managed by different administrators, the information processing device comprising a control unit configured to:
acquire first information about utilization of renewable energy for each of the at least two access networks; and
select an access network to be used from the at least two access networks based on the first information for each of the at least two access networks.

2. The information processing device according to claim 1, wherein:
the first information includes a renewable energy utilization rate in a wireless communication system that manages the access network; and
the control unit is configured to select, as the access network to be used, an access network with a higher value of the renewable energy utilization rate.

3. The information processing device according to claim 1, wherein:
the first information includes a renewable energy utilization rate in a device that accommodates an access network in which the information processing device is currently located or expected to be located; and
the control unit is configured to select, as the access network to be used, an access network with a higher value of the renewable energy utilization rate.

4. The information processing device according to claim 1, further comprising:
a first embedded universal integrated circuit card that holds information to be used for connection to a first carrier network; and
a second embedded universal integrated circuit card that holds information to be used for connection to a second carrier network, wherein
the control unit is configured to:
acquire the first information for each of the first carrier network and the second carrier network; and
select the access network to be used from the first carrier network and the second carrier network based on the first information for each of the first carrier network and the second carrier network.

5. A method to be executed by an information processing device connectable to at least two access networks managed by different administrators, the method comprising:
acquiring first information about utilization of renewable energy for each of the at least two access networks; and
selecting an access network to be used from the at least two access networks based on the first information for each of the at least two access networks.
